(19) United States
(12) Patent Application Publication
(10) Pub. No.: US 2007/0114289 A1
(43) Pub. Date: May 24, 2007

(54) Method and apparatus for promoting a customer to return to, visit, or contact a business

(75) Inventor: John Boldebuck, Lombard, IL (US)

Correspondence Address: BRINKS HOFER GILSON & LIONE, P.O. BOX 10395, CHICAGO, IL, 60610, US

(73) Assignee: Bold Innovations, LLC

(21) Appl. No.: 11/285,129

(22) Filed: Nov. 21, 2005

(51) Int. Cl. G06K 19/00; G07G 1/14

(52) U.S. Cl. 235/487; 705/14

(57) ABSTRACT

A card apparatus for promoting a customer to return to or visit or contact a business includes a card, indicia on the card indicating in some fashion that the card is not a functional card, and a removable covering attached to the card that covers the indicia. The card apparatus can be issued to a customer that has or has not visited or contacted a business. The customer is given an incentive to return to or visit or contact the business with the card apparatus to receive some benefit, such as a free gift. By promoting a customer to return to or visit or contact a business, the business increases its chances that the customer will purchase a product or service from the business or will otherwise make a transaction that will benefit the business.

### TECHNICAL FIELD

The present disclosure relates generally to the promotion of a customer to return to, visit, or contact a business, and, more particularly, to a promotional card, such as a promotional credit card, which can be used in an effort to promote a customer to return to, visit, or contact a business.

### BACKGROUND

Promotional cards, such as promotional credit cards, are non-functional financial cards that simulate real, functional financial cards in appearance. Promotional cards are often provided to consumers as part of a marketing effort to encourage consumers to apply for a particular credit card that is the subject of the promotion. It can be desirable to make the promotional card appear identical or substantially identical to the real, functional card that it simulates. This close simulation gives consumers the ability to see and feel the credit card that may be applied for, which can increase consumers' likelihood of applying for the credit card. For example, a consumer may be more likely to open a promotional direct mailing in which an apparently real financial card appears in a window of the envelope.

A typical real, functional financial card, such as a credit card, is made of plastic (e.g., PVC laminated plastic) and has information that is embossed (i.e. raised) on the card. For example, the string of numbers (often called the “credit card number”), the expiration date, the name of the person who owns the credit card, and/or other information can be embossed on the card.

Despite the desire to make a promotional card appear identical or substantially identical to the real, functional card that it simulates, promotional cards are often issued as cardboard cards. Even when promotional cards are issued as plastic cards, the information included on the card is printed, not embossed, and the cards are usually made from an inferior grade plastic (e.g., real, functional cards are often 30 mm plastic whereas promotional cards can be 10 mm plastic). Promotional cards are issued as cardboard cards or inferior grade plastic cards without embossing because credit card companies, such as VISA®, MASTERCARD®, and AMERICAN EXPRESS®, have refused to allow them to be issued as standard grade plastic cards with embossing based on the fear that they may be improperly used to make a financial transaction even though they are not real, functional cards. Credit card companies are concerned that, if the promotional card simulates the real, functional card too closely, businesses may be deceived—intentionally or unintentionally—into providing goods or services based on the promotional card.

This problem can be magnified for businesses that use carbon copy paper to make an imprint of a credit card as a basis for payment (in contrast to businesses that swipe the credit card through a point of sale terminal). Information that is embossed on a promotional card will be captured in the imprint, similar to an imprint for a real, functional financial card, which can deceive businesses into believing that the promotional card is a real, functional financial card. Credit card companies may be liable for financial cards that are taken by a business in error.

### SUMMARY

Discussed below, among other things, is a card apparatus that may be issued as a plastic promotional card with embossing. According to a first aspect of the disclosure, the card apparatus includes a card, a removable covering attached to the card, and indicia on the card indicating that the card is not a functional card. The covering can cover the indicia when the covering is attached to the card. The card can be made from a standard grade plastic similar to a conventional real, functional financial card.

In another aspect of the disclosure, a card apparatus can be used in a method to promote a customer to return to a business. The method includes issuing a customer a card that promotes the customer to return to a business, wherein the card includes indicia indicating that the card is not a functional card and further includes a removable covering that covers the indicia, and communicating at least one benefit to the customer that can be realized if the customer returns to the business with the card.

In yet another aspect of the disclosure, a card apparatus can be used in a method to promote a customer to visit or contact a business. The method includes identifying a customer that has not visited or contacted the business, issuing the customer a card that promotes the customer to visit or contact the business, wherein the card includes indicia indicating that the card is not an immediately functional card and further includes a removable covering that covers the indicia, giving the customer an incentive to visit or contact the business, and providing the customer with at least one benefit if the customer visits or contacts the business.

### BRIEF DESCRIPTION OF THE DRAWINGS

For the purpose of facilitating an understanding of the subject matter sought to be protected, there is illustrated in the accompanying drawings an embodiment thereof, from an inspection of which, when considered in connection with the following description, the subject matter sought to be protected, its construction and operation, and many of its advantages should be readily understood and appreciated.

FIG. 1 is a plan view of a card apparatus for promoting a customer to return to, visit, or contact a business.

FIG. 2 is a plan view of a card apparatus for promoting a customer to return to, visit, or contact a business.

FIG. 3 is a flow diagram of a method for promoting a customer to return to a business.

FIG. 4 is a flow diagram of a method for promoting a customer to visit or contact a business.

### DETAILED DESCRIPTION OF THE PRESENTLY PREFERRED EMBODIMENTS

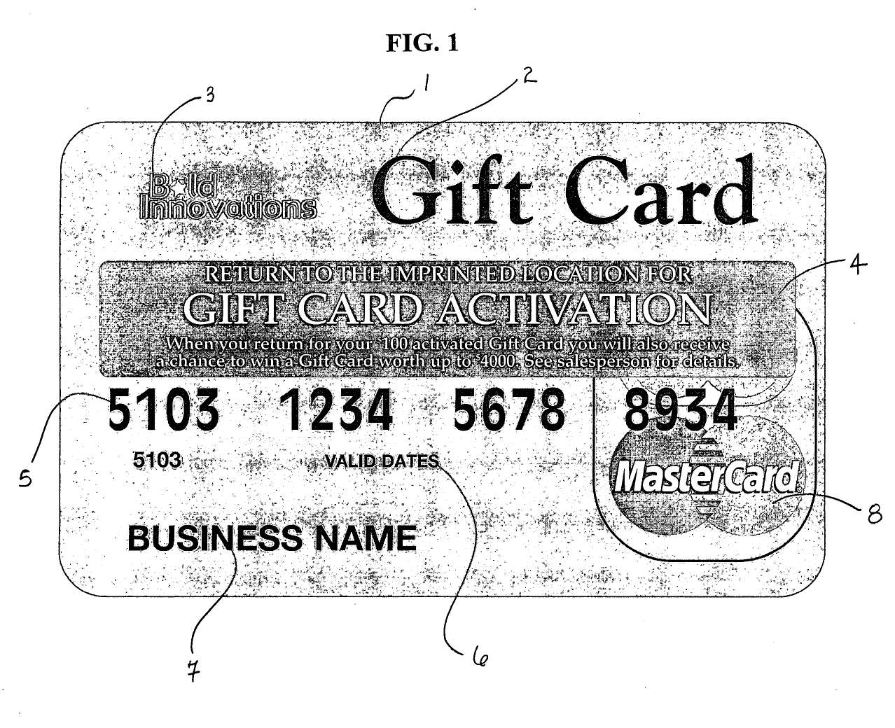

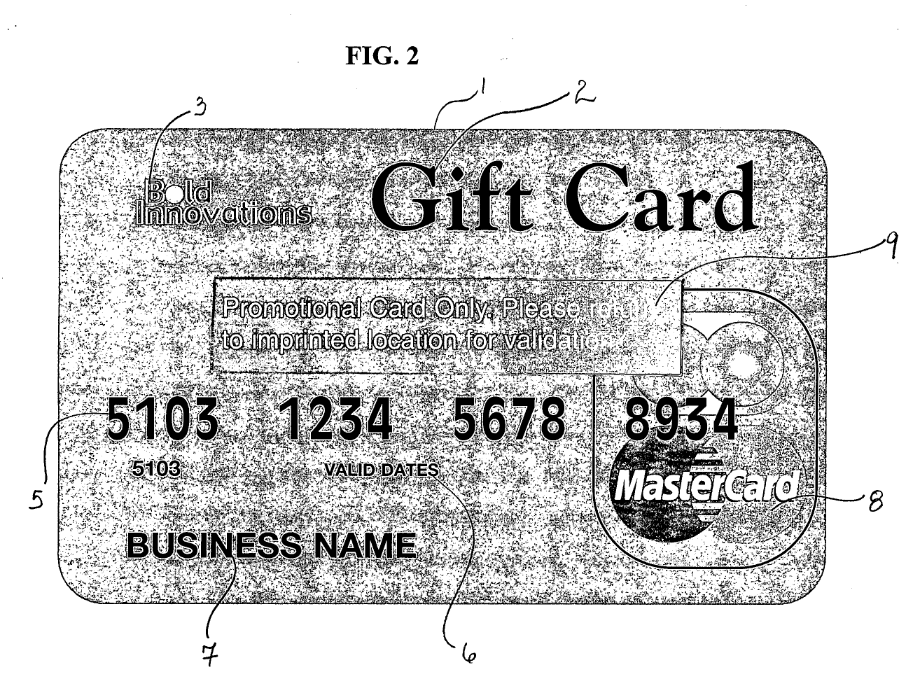

An embodiment of a card apparatus for promoting a customer to return to or visit or contact a business is shown in FIGS. 1 and 2. The term “business” used herein refers broadly to any entity (such as corporations, partnerships, or the like) or individual (such as a realtor, self proprietor, or the like). The term “customer” used herein broadly includes customers (whether past or present customers) and potential customers, whether known or unknown to a business.

The card apparatus includes a card 1. The card 1 has the appearance of being a real, functional financial card, but as further described below, the card 1 is non-functional or at least is not immediately functional. Several features give the card 1 the appearance of being a real, functional financial card. First, the card 1 has a size and shape similar to a conventional financial card, such as a credit card. The card 1 is preferably made of plastic, like a conventional financial card, but it can be made of cardboard or any other suitable material. The card 1 can be made from the same grade of plastic that conventional real, functional financial cards are made from. For example, the card 1 can be made from 30 mm plastic or some other grade.

Second, the term “Gift Card” 2 is printed on the card 1. This term implies that the card 1 is a stored-value card which entitles the card holder to purchase any item at the designated business 7 as long as the purchase price is equal to or less than the value stored on the card 1. Other similar terms may be used in place of the term “Gift Card” 2, such as “Credit Card,” “Debit Card,” “Store Charge Card,” or the like. In the alternative, the card 1 may not include the term “Gift Card” 2 or any other similar term, or the term may be embossed on the card 1.

Third, the card 1 includes a string of numbers 5 similar to the string of numbers that appears on a conventional financial card. The numbers 5 may be embossed (i.e. raised) or may be printed on the card 1 and not embossed. The numbers 5 are preferably unique so that each card 1 contains a different string of numbers, but the numbers may be non-unique. In the alternative, the card 1 may not include a string of numbers or may include less or more numbers than what are included on a conventional financial card.

Fourth, the card 1 includes the brand name designation MASTERCARD® 8 similar to a conventional financial card. Other brand name designations may be used in place of MASTERCARD® 8, such as VISA®, AMERICAN EXPRESS®, or DISCOVER®. In addition, a brand name designation corresponding to the business issuing the card may be used. For example, the designations TARGETS®, SEARS®, or THE HOME DEPOT® may be used to mimic department store charge cards, and the designations SHELLS®, AMOCO®, or CITGO® may be used to mimic fuel charge cards. In the alternative, the card 1 may not include any brand name designation or may include a combination of brand name designations.

Finally, the card I includes a date or set of dates 6 (i.e. an expiration date), similar to a conventional financial card. The date 6 listed on the card 1 is preferably sometime after the date the card 1 is issued, but it can be sometime before that date or the same date. The date 6 may correspond to the date by which a customer must return to the business issuing the card 1 to receive some benefit, as further discussed below. In the alternative, the date 6 may be arbitrarily set or the card 1 may not include any date whatsoever. The date 6 can be embossed on the card or printed on the card and not embossed.

The card 1 may also include a generic name printed or embossed on the card 1, such us “Jane Doe” or “John Doe.” Generally speaking, most or all of the features that are traditionally used with a conventional promotional card can be used with the card 1 disclosed herein. Furthermore, most or all of the features that are traditionally used with a conventional real, functional financial card can be used with the card 1 disclosed herein, unless this disclosure expressly states otherwise.

While the card 1 has the appearance of being a real, functional financial card, the card 1 is not actually functional. It cannot be used to make a financial transaction. For example, unlike a conventional financial card, the card 1 does not include a magnetic strip on the backside, although it can include a black stripe simulating a magnetic strip. If the card is swiped through a point of sale terminal, such as a terminal used by a waiter/waitress at a restaurant, the card will not be readable, will not be recognized by the terminal, and should be declined. Similarly, if the card is used in an attempt to purchase something online (i.e. via the Internet), such as a book from AMAZON.COM®, the card should be declined, because the string of numbers 5 and valid dates 6 do not correspond with a real, functional financial card.

The card apparatus further includes a removable covering attached to the card 1, such as a sticker 4. Other possible coverings include a scratchable film (like the film that can be scratched off on an instant lottery ticket), a water soluble paste (which can be removed by placing the card in water), or any other suitable means. The discussion herein regarding the sticker 4 also applies to all such other possible removable coverings.

The sticker 4 can include information promoting a customer to return to a business. In the example shown in FIG. 1, the sticker 4 states: “RETURN TO THE INDICATED LOCATION FOR GIFT CARD ACTIVATION . . . When you return for your $100 activated Gift Card you will also receive a chance to win a Gift Card worth up to $4000. See salesperson for details.” The information provided on the sticker 4 can be determined on a case-by-case basis depending on the particular circumstances of the issuance of the card 1. For example, the sticker 4 may state: “DO NOT REMOVE THIS STICKER UNTIL YOU HAVE RETURNED TO ISSUER.” The sticker 4 may also include a logo or brand name associated with the business issuing the card apparatus, such as GENERAL MOTORS®, REMAX REALTY®, or MICHIGAN STATE UNIVERSITY®. In the alternative, the sticker 4 may be blank. The sticker 4 may be opaque, translucent, partially opaque, or partially translucent. Only one sticker can be used or more than one sticker, such as 2, 3, 4, 5, or more stickers can be used.

The sticker 4 can be peeled off to reveal indicia 9 on the card 1 indicating in some fashion that the card 1 is not a functional card. In the example shown in FIG. 2, the indicia 9 states: “Promotional Card Only. Please return to imprinted location for validation.” Other similar statements can be used. For example, the indicia may state: “Not a real card,” “Not an actual card,” “Not a functional card,” “Promotional card only,” “Do not attempt to use,” “Return to issuer for an activated card,” or “Return to issuer for activation.” The particular words used are not important as long as the concept that the card 1 is not a functional card is conveyed by the indicia 9. The information provided on the indicia 9 can be determined on a case-by-case basis depending on the particular circumstances at issue. The indicia 9 can be embossed (i.e. raised) or it can be printed on the card 1 and not embossed.

The sticker 4 preferably covers the indicia 9 when the sticker 4 is attached to the card 1. In the alternative, the sticker 4 may only partially cover the indicia 4 or it may not cover the indicia 4 whatsoever. Preferably, the sticker 4 does not cover the string of numbers 5. The portion of the card 1 covered by the sticker 4, the indicia 9, and/or the portion of the card 1 immediately surrounding the indicia 9 can be visually contrasting to other portions of the card 1, such as the portions not covered by the sticker 4. For example, the portion of the card 1 covered by the sticker 4 can be one color and the other portions of the card can be a different color. The sticker 4 can likewise be visually contrasting (e.g. a different color) to the portion of the card 1 covered by the sticker 4 and/or the other portions of the card 1. In the alternative, the card 1 and sticker 4 may be the same color or some other color variations may be used.

Thus, the present disclosure provides a promotional card that may be issued as a plastic card with embossed information, like a conventional financial card. The card 1 includes indicia 9 under the sticker 4, which can specifically communicate that the card 1 is not a real, functional card. The previous concern that promotional cards may be improperly used if they are issued as standard grade plastic cards with embossed information, as discussed above, does not exist or at least is minimized with the card 1. For example, a business is unlikely to be deceived into providing goods or services based on the card when the sticker 4 remains on the card 1. If the sticker 4 is removed, the business remains unlikely to be deceived in view of the indicia 9. In embodiments where the indicia 9 is embossed on the card 1, furthermore, businesses that use carbon copy paper to make an imprint of a financial card as a basis for payment are unlikely to be deceived into believing that the card 1 is a real, functional card because, among other reasons, the indicia 9 will show up on any carbon copy imprint made of the card 1. In addition, the likelihood a business may be deceived with a promotional card can be further minimized by making the indicia 9 and/or the portion of the card immediately surrounding the indicia 9 visually contrasting from the rest of the card 1, which makes it stand out when the sticker 4 is removed from the card 1. As a result, promotional cards incorporating the present disclosure may be issued as embossed, plastic cards (made from standard grade plastic) without the traditional concerns of improper use. Promotional cards incorporating the present disclosure may also be issued as cards made from some material other than plastic (or some grade of plastic other than the standard grade) or may be issued as cards without any embossing.

The card 1 may be used in a method for promoting a customer to return to a business. The card 1 may be issued to a customer who contacts or visits a business. The contact or visit may be in-person, via telephone, via e-mail, via letter or facsimile, via the Internet, or via any other suitable means. Depending on the means by which the business is contacted or visited, the card 1 can be issued to the customer by physically handing it to the customer at the place of business, by mailing it to the customer, by hand-delivering it to the customer, by leaving it at a designated location for pick-up by the customer, or by any other suitable means. The card 1 may be issued to the customer by the business alone such as TARGETS®, a car dealership, or a realtor. The card 1 may also be issued by a credit card company such as MASTERCARD®, VISA®, AMERICAN EXPRESS®, or DISCOVER(®. In a further alternative, the card 1 may be issued by the business on behalf of, in connection with, or with the authorization of a credit card company.

The customer is given an incentive to return the card 1 to the business, as further discussed below, which correspondingly means that the customer may return to the business. Like the contact or visit, the return to a business may be in-person, via telephone, via e-mail, via letter or facsimile, via the Internet, or via any other suitable means. By promoting a customer to return to a business, the business increases its chances that the customer will purchase a product or service from the business or will otherwise make a transaction that will benefit the business.

The card 1 is preferably issued to only those customers that visit or contact a business and do not purchase a product or service at the business (or otherwise make a transaction to the benefit of the business) during the visit or contact. The card 1, however, can also be issued to other customers. The card 1 can be issued to those customers that visit or contact a business and actually purchase a product or service at the business (or otherwise make a transaction to the benefit of the business).

In addition, the card 1 may be issued to customers that do not visit or contact the business or have not visited or contacted the business. For example, the card 1 can be handed out during a trade show, it can be sent to customers through random direct mailings, it can be included in advertisements appearing in magazines or other publications, it can be distributed door-to-door, or it can be issued via any other suitable means. In such instances, the card is used to promote a customer to visit or contact a business, rather than to promote a customer to return to a business. The discussion herein regarding the promotion of a customer to return to a business, however, is equally applicable to the promotion of a customer to visit or contact a business for the first time. In either situation, the goal is to promote a customer to make a transaction that will benefit the business, such as the purchase of goods or services offered by the business.

The means by which the card 1 is issued to a customer can be determined on a case-by-case basis depending on the particular circumstances at issue, including, for example, the products or services at issue and the target customer. The target customer, furthermore, can also be identified on a case-by-case basis. In one alternative, for example, a customer that has not visited or contacted a business can be identified by comparing a computer database of potential recipients of the card with a computer database of known customers of the business and determining which of the potential recipients are not known customers. In other alternatives, the customer can be identified on the basis of some desired or qualifying criteria, such as a desired geographic location, demographic, credit rating, or interest in a particular subject matter.

An incentive to return the card 1 to the business may be communicated to the customer. Preferably, at least one benefit that can be realized if the customer returns to the business with the card 1 is communicated to the customer when the card 1 is initially issued to the customer, although it may be communicated at some other time. The potential benefit or benefits can be communicated to the customer in the following ways. The benefits can be relayed orally to the customer, can be identified in a brochure provided or otherwise made available to the customer, can be identified in an e-mail, letter, facsimile, or other written communication to the customer, can be published on a website accessible via the Internet, or can be communicated via any other suitable means, such as identifying the potential benefit or benefits on the sticker 4.

The benefit or benefits can be determined on a case-by-case basis depending on the circumstances at issue. Possible benefits include the following examples. The card 1 may be exchanged for a functional, activated stored-value gift card, credit card, store charge card, or fuel card. For this benefit, the stored-value can be determined by the business issuing the card 1, but can be $50.00, for example. In addition, the string of numbers 5 on the card 1 may be used to enter the customer into a sweepstakes, promotion, contest, and/or raffle. For this benefit, the prize can be determined by the business issuing the card 1, but can be money, a vacation, or a material object, such as a stereo, for example.

Other possible benefits may be directly related to the products or services offered by the business. For example, a car dealership issuing the card 1 may provide a complimentary (free) oil change, car wash, car check-up, or rental car if the customer returns to the dealership with the card 1. In addition, the customer may be provided with a discount (e.g., 10%, 20%, etc.) on all goods and services offered by a business on the day (or for the week or some other amount of time) that the customer returns to the business with the card 1. If the customer does not return to the business within the allowed time, if any, the customer may not receive any of the possible benefits communicated to the customer.

The potential benefits may be contingent on something, such as the purchase of a good or service from the business (or some other transaction). For example, a business may require a customer returning with the card 1 to purchase at least $10.00 (or some other dollar value) of goods or services from the business before the business will issue the customer a stored-value credit card worth $100.00 (or some other dollar value). In addition, the customer may be required to return in-person to the business with the card 1, rather than return by phone or e-mail, for example. Preferably, however, the potential benefits are not contingent on anything other than the customer returning to the business with the card 1.

The potential benefits can also be contingent on the customer returning to the business within a certain period of time. As discussed above, the date 6 on the card 1 can correspond to the date by which a customer must return to the business issuing the card 1 to receive some benefit, similar to an expiration date for a coupon, for example. If the customer does not return to the business by the date 6, the customer may no longer be eligible to receive the benefits that it otherwise would have received if it had returned before the date 6. In other alternatives, the date by which a customer must return to a business to receive some benefit may be different than the date 6 or no expiration date may be set whatsoever.

The potential benefits can also be varied among customers based on some criteria. For example, the value of a free stored value gift card given to customers that return to a business can be varied depending on criteria such as a given customer's credit rating, yearly income, or amount of purchases made by the customer at the business in the past. The dollar value of the stored value gift card, for example, can be increased for customers with a high credit rating, high early income, or large amount of purchases at the business in the past. Other numerous variations of the possible benefits are readily apparent and can be determined on a case-by-case basis depending on the circumstances at issue. For example, a car dealership can make one benefit, such as a free car wash, available only to owners of cars less than 5 years old, and make another benefit, such as a free car check-up, available only to owners of cars greater than 5 years old.

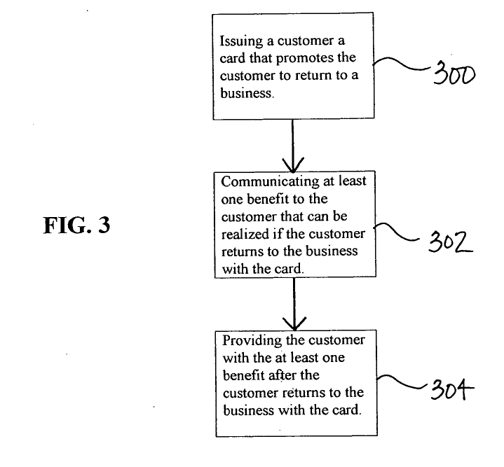

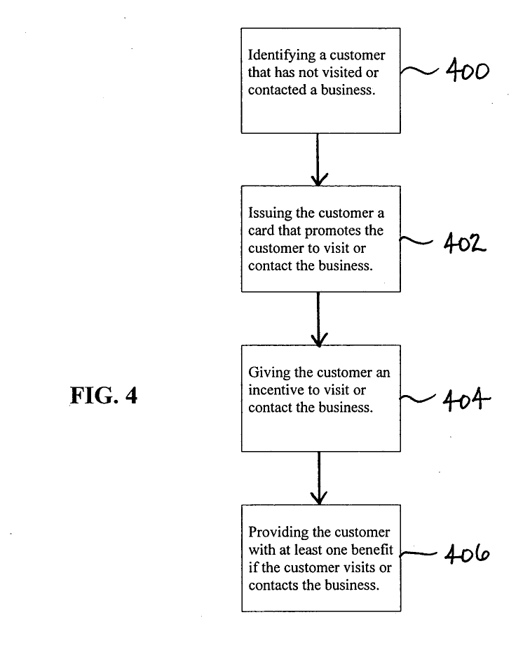

FIGS. 3 and 4 represent flow diagrams of exemplary methods for promoting a customer to visit, contact, or return to a business using, for example, the card apparatus described above. It should be understood, however, that the method steps illustrated by the blocks in these figures may be performed in other sequences, other steps may be added, and/or one or some of the steps may be skipped, deleted, or performed simultaneously with another step or other steps. In addition, the method steps may be carried out with a card apparatus other than the apparatus expressly described above.

FIG. 3 is a block diagram showing an exemplary method for promoting a customer to return to a business. At block 300, a card that promotes the customer to return to a business is issued. The card can include indicia indicating in some fashion that the card is not a functional card and a removable covering, such as a sticker, which covers the indicia. The card can be issued (by the business, for example) only to customers that visit or contact the business and do make a purchase from the business during the visit or contact, or it can be issued to other customers.

At block 302, at least one benefit to the customer that can be realized if the customer returns to the business with the card is communicated to, for example, the customer. The benefit can be communicated, for example, in a brochure provided or made available to the customer. The steps at blocks 300 and 302 can be performed at the same time or substantially at the same time.

At block 304, the customer is provided with the at least one benefit after the customer returns to the business with the card. The benefit can be provided in person, through the mail, over the Internet (via e-mail, for example), over the phone, or through any other suitable means. In some instances, the benefit may only be provided in person, which promotes face-to-face contact between the customer and business. In further instances, the benefit may only be provided if the customer returns to the business before an expiration date, if any, such as an expiration date on the card. The benefit can be, for example, a real, functional stored-value card, the entry in a raffle, and/or it can be directly related to the products or services offered by the business, such as a discount on goods or services offered by the business.

FIG. 4 is a block diagram showing an exemplary method for promoting a customer to visit or contact a business. At block 400, a customer that has not visited or contacted a business is identified. This step can be performed, for example, by comparing a database of potential recipients of the card with a database of known customers of the business and determining which of the potential recipients are not known customers. Customers that have not visited or contacted a business can also be identified through any other suitable means, such as simply asking a customer whether he or she has visited or contacted the business.

At block 402, a card that promotes the customer to visit or contact the business is issued to the customer. The card can include indicia indicating in some fashion that the card is not an immediately functional card and a removable covering that covers the indicia. At block 404, the customer is given an incentive to visit or contact the business with the card. The incentive can include a potential benefit to the customer.

At block 406, the customer is provided with at least one benefit if the customer visits or contacts the business. In some instances, the providing of a benefit can be made contingent on the customer making a purchase from the business.

The foregoing description has been presented to illustrate the principles of the invention and not to limit the invention to any particular embodiment illustrated. It is therefore intended that the foregoing detailed description be regarded as illustrative rather than limiting, and that it be understood that it is the following claims, including all equivalents, that are intended to define the spirit and scope of this disclosure.

1. A card apparatus for promoting a customer to return to a business comprising:
(a) a card,
(b) a removable covering attached to the card,
(c) indicia on the card indicating that the card is not a functional card, wherein the covering covers the indicia when the covering is attached to the card.

2. The card apparatus of claim 1 wherein the card is plastic and is comprised of a string of numbers that are embossed on the card.

3. The card apparatus of claim 2 wherein the card is comprised of an expiration date that is embossed on the card, and the string of numbers and expiration date do not correspond with a real, functional financial card.

4. The card apparatus of claim 1 wherein the covering is comprised of a sticker or scratchable film.

5. The card apparatus of claim 1 wherein the covering comprises information promoting a customer to return to a business.

6. The card apparatus of claim 1 wherein a portion of the card covered by the covering is visually contrasting with a remaining portion of the card.

7. The card apparatus of claim 1 wherein the indicia directs a customer to return to a business.

8. A method for promoting a customer to return to a business comprising:
(a) issuing a customer a card that promotes the customer to return to a business, wherein the card comprises indicia indicating that the card is not a functional card and further comprises a removable covering that covers the indicia; and
(b) communicating at least one benefit to the customer that can be realized if the customer returns to the business with the card.

9. The method for promoting a customer to return to a business of claim 8 further comprising:
(c) providing the customer with the at least one benefit after the customer returns to the business with the card.

10. The method for promoting a customer to return to a business of claim 9 wherein step (c) is only performed in person between the customer and the business.

11. The method for promoting a customer to return to a business of claim 8 wherein the card is only issued to customers that visit or contact the business and do not make a purchase from the business during the visit or contact.

12. The method for promoting a customer to return to a business of claim 8 wherein steps (a) and (b) are performed at the same time or substantially at the same time.

13. The method for promoting a customer to return to a business of claim 8 wherein the at least one benefit is communicated to the customer in a brochure provided or made available to the customer.

14. The method for promoting a customer to return to a business of claim 8 wherein the card is comprised of an expiration date, and the expiration date corresponds with a date by which the customer must return to the business to receive the at least one benefit.

15. The method for promoting a customer to return to a business of claim 8 wherein the at least one benefit is an entry in a raffle.

16. The method for promoting a customer to return to a business of claim 8 wherein the at least one benefit is directly related to products or services offered by the business.

17. The method for promoting a customer to return to a business of claim 8 wherein the business performs step (a).

18. A method for promoting a customer to visit or contact a business comprising:
(a) identifying a customer that has not visited or contacted a business;
(c) issuing the customer a card that promotes the customer to visit or contact the business, wherein the card comprises indicia indicating that the card is not an immediately functional card and further comprises a removable covering that covers the indicia;
(d) giving the customer an incentive to visit or contact the business; and
(e) providing the customer with at least one benefit if the customer visits or contacts the business.

19. The method for promoting a customer to visit or contact a business of claim 18 wherein step (e) is only performed if the customer makes a purchase from the business.

20. The method for promoting a customer to visit or contact a business of claim 18 wherein step (a) is performed by comparing a database of potential recipients of the card with a database of known customers of the business and determining which of the potential recipients are not known customers.
